(19) United States
(12) Patent Application Publication
(10) Pub. No.: US 2013/0044819 A1
(43) Pub. Date: Feb. 21, 2013

(54) DECODING A VARIABLE LENGTH CODE

(71) Applicants: Phani Kumar Uppalapati, Ongole (IN); Ganesh Guddanti, Bangalore (IN)

(72) Inventors: Phani Kumar Uppalapati, Ongole (IN); Ganesh Guddanti, Bangalore (IN)

(21) Appl. No.: 13/210,555

(22) Filed: Aug. 16, 2011

(51) Int. Cl. H04N 7/26

(52) U.S. Cl. 375/240.23; 375/E07.027

(57) ABSTRACT

An apparatus generally having a first circuit and a plurality of lookup tables is disclosed. The first circuit may be configured to parse a fixed number of bits from a first signal. The bits may contain a variable length code. The lookup tables may be configured to (i) generate a first value, a second value and a third value from a first and a second of the tables based on the bits and (ii) generate a second signal from a third of the tables based on the first value, the second value and the third value. The second signal generally conveys a symbol decoded from the variable length code.

### FIELD OF THE INVENTION

The present invention relates to lossless data compression generally and, more particularly, to a method and/or apparatus for decoding a variable length code.

### BACKGROUND OF THE INVENTION

Uncompressed digital video sequences consume significant memory for storage and large data rates for transmission. Therefore, digital video compression has become a common area of research and standardization for use with practical multimedia applications in the recent decades. Typical video compression techniques are transform-based. A discrete cosine transform (i.e., DCT) is a common transform technique. During an encoding process, an input video sequence is divided into a group of pictures. Each picture is divided into slices. Each slice contains several consecutive macroblocks (i.e., MB) of m×n pixels. Common sizes of macroblock are 16×16, 8×16, 16×8 and 8×8 pixels.

Each MB in an intra-coded picture (i.e., I-picture) is divided into smaller blocks. The sizes of the smaller blocks vary based on a particular video compression scheme. A DCT matrix is computed for each smaller block. For predicted pictures (i.e., P-pictures) and bi-predictive pictures (i.e., B-pictures), a current macroblock is predicted with a motion estimation technique using a reference I-picture or P-picture. Once the reference macroblock is obtained, a motion compensation technique calculates a pixel-wise difference between the current macroblock and the reference macroblock. The residual is a pixel-wise difference known as motion-compensated macroblock (i.e., MCMB). Each MCMB for the P-pictures or the B-pictures is divided into smaller blocks. The size of the smaller blocks vary based on a particular video compression scheme. A DCT matrix is computed for each smaller block. After quantization, a number of the high-frequency DCT coefficients have a value of zero.

A form of lossless coding, called run-length coding, is used to take advantage of the zero values by grouping consecutive zero-valued coefficients and encoding the number of consecutive zero-valued coefficients instead of encoding the individual zero-valued coefficients. Run-length coding is typically followed by an entropy coding technique known as variable-length coding (i.e., VLC). The variable-length coding is usually either a Huffman coding or an arithmetic coding.

Furthermore, VLC is normally applied to many other blocks of the data at various stages of the video coding/decoding techniques, including differentially coded DC coefficients of smaller blocks, specifying macroblock address increments and differentially encoded motion vectors.

The codewords generated by the VLC encoding process become part of a bitstream created by the video encoder/video compression. At the video decoder side, decoding the VLC codewords and mapping the codewords back to the original values consumes a significant amount read-only memory (i.e., ROM) for associated tables when a good performance in terms of clock cycles is specified. Because of a binary-tree parsing nature of VLC decoding techniques, common practices trade off the performance in terms of clock cycles against the size of ROM used for the VLC decoding.

Conventional video codecs use significant table space for transform computation, quantization, VLC encoding, VLC decoding and filters. Reducing the memory size wherever possible in the final implementation of a video codec is helpful to the system designers.

It would be desirable to implement a method and/or apparatus for decoding a variable length code.

### SUMMARY OF THE INVENTION

The present invention concerns an apparatus generally having a first circuit and a plurality of lookup tables. The first circuit may be configured to parse a fixed number of bits from a first signal. The bits may contain a variable length code. The lookup tables may be configured to (i) generate a first value, a second value and a third value from a first and a second of the tables based on the bits and (ii) generate a second signal from a third of the tables based on the first value, the second value and the third value. The second signal generally conveys a symbol decoded from the variable length code.

The objects, features and advantages of the present invention include providing a method and/or apparatus for decoding a variable length code that may (i) use less table memory space than conventional designs, (ii) maintain performance in terms of clock cycles, (iii) decode Huffman codes, (iv) decode macroblock address increment symbols, (v) form part of an MPEG-2 decoder and/or (vi) use new lookup tables.

### BRIEF DESCRIPTION OF THE DRAWINGS

These and other objects, features and advantages of the present invention will be apparent from the following detailed description and the appended claims and drawings in which:

FIG. 1 is a block diagram of an example video picture;

FIG. 2 is a block diagram of a system;

FIG. 3 is a block diagram of an example implementation of a variable length code decoder circuit of the system in accordance with a preferred embodiment of the present invention;

FIG. 4 is a flow diagram of an example method for variable length code decoding of a symbol;

FIG. 5 is a diagram of an example parsing of bits from a signal; and

FIG. 6 is a diagram illustrating example bit-field extractions based on the width value and the offset value.

### DETAILED DESCRIPTION OF THE PREFERRED EMBODIMENTS

Some embodiments of the present invention generally provide decoding of variable length codes (e.g., VLC). The variable length codes may include, but are not limited to, Huffman codes. Symbols represented by the variable length codes generally include macroblock address increment (e.g., MBA_INC) values (or symbols) that are used in part of an MPEG-2 video decoder. Multiple tables used in the VLC decoding may occupy a low amount of memory compared with implementations for the same objective in existing MPEG-2 video decoders. Furthermore, the tables may be used efficiently to minimize a number of clock cycles used in the lookups.

A small read-only memory (e.g., ROM) size is generally achieved by using several small lookup tables instead of a single large table. The several tables may also result in better performance in terms of clock cycles and so may be particularly useful with the Huffman decoding of the MBA_INC values when decoding an MPEG-2 bitstream. The reduced memory utilization for decoding the MBA_INC values generally helps in optimizing the performance of other video processing blocks. The lookup tables may also enable efficient implementations of MPEG-2 video decoders. The terms “video codec”, “video compression/decompression” and “video encoder/decoder” may be used interchangeably.

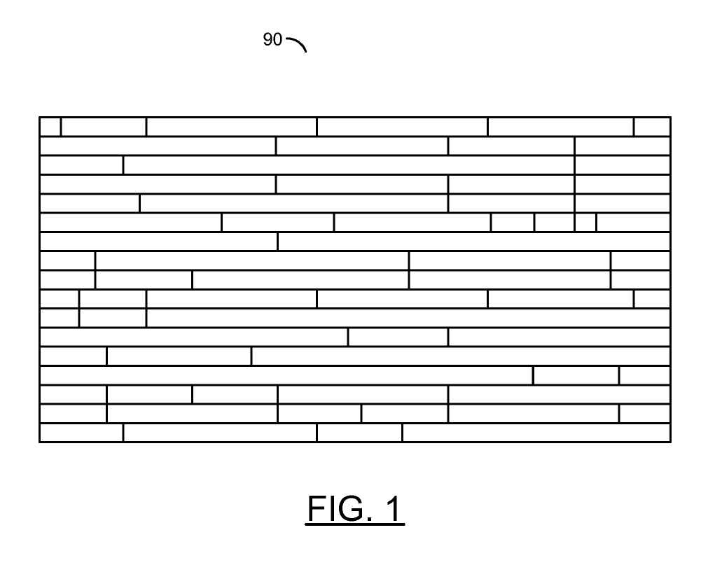

Referring to FIG. 1, a block diagram of an example video picture 90 is shown. The example picture (or field or frame) 90 generally illustrates multiple slices (rectangles) each containing one or more macroblocks. In an MPEG-2 video encoder, a macroblock (e.g., MB) may be a 16×16 pixel unit of information and each MB begins with a macroblock header. A slice is generally a string of consecutive MBs of arbitrary length running from left to right across the picture 90.

According to the MPEG-2 codec, a left edge of the picture 90 may start each new slice. For intra-coded pictures (e.g., I-pictures), all MBs may be transmitted from an encoder to a decoder and/or a storage device. For predicted pictures (e.g., P-pictures) and bi-predictive pictures (e.g., B-pictures), typically some MBs of a slice may be transmitted and some may not be transmitted from the encoder. The MBs not transmitted may be considered skipped MBs. However, an initial MB and a final MB of each slice may always be transmitted. A slice may not be allowed to extend beyond the right edge of the picture 90. Furthermore, slices may not overlap each other. For the initial MB of each slice, a horizontal position with respect to the left edge of the picture 90 (in MBs) may be coded such that the corresponding MBA_INC value is mapped into an MBA_INC variable length code (e.g., MBA_INC_VLC). Table I generally illustrates the mapping between the MBA_INC_VLC codes and the MBA_INC values as follows:

TABLE I

| Macroblock_Address_Increment | Macroblock_Address_Increment |
|---|---|
| VLC Codes | Value (Symbols) |
| 1 | 1 |
| 011 | 2 |
| 010 | 3 |
| 0011 | 4 |
| 0010 | 5 |
| 0001 1 | 6 |
| 0001 0 | 7 |
| 0000 111 | 8 |
| 0000 110 | 9 |
| 0000 1011 | 10 |
| 0000 1010 | 11 |
| 0000 1001 | 12 |
| 0000 1000 | 13 |
| 0000 0111 | 14 |
| 0000 0110 | 15 |
| 0000 0101 11 | 16 |
| 0000 0101 10 | 17 |
| 0000 0101 01 | 18 |
| 0000 0101 00 | 19 |
| 0000 0100 11 | 20 |
| 0000 0100 10 | 21 |
| 0000 0100 011 | 22 |
| 0000 0100 010 | 23 |
| 0000 0100 001 | 24 |
| 0000 0100 000 | 25 |
| 0000 0011 111 | 26 |
| 0000 0011 110 | 27 |
| 0000 0011 101 | 28 |
| 0000 0011 100 | 29 |
| 0000 0011 011 | 30 |
| 0000 0011 010 | 31 |
| 0000 0011 001 | 32 |
| 0000 0011 000 | 33 |
| 0000 0001 000 | macroblock_escape |

The positions of additional transmitted MBs in the slice may be coded differentially with respect to the most recently transmitted MB, also using the MBA_INC_VLC codes. The “macroblock_escape” value is generally used for addresses and/or differentially encoded address increments larger than a maximum value (e.g., 33).

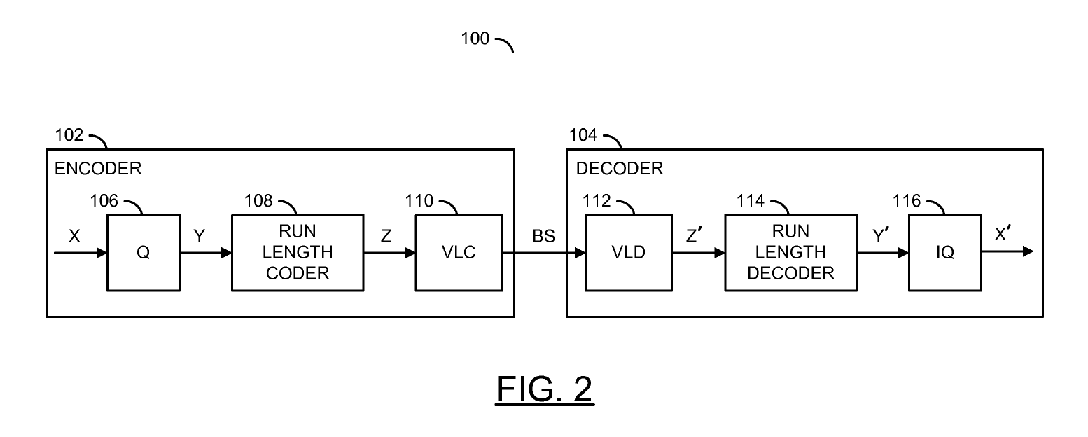

Referring to FIG. 2, a block diagram of a system 100 is shown. The system (or circuit or device or apparatus or integrated circuit) 100 may implement a video codec system. The system 100 generally comprises a block (or circuit) 102 and a block (or circuit) 104. The circuit 102 generally comprises at least a block (or circuit) 106, a block (or circuit) 108 and a block (or circuit) 110. The circuit 104 generally comprises at least a block (or circuit) 112, a block (or circuit) 114 and a block (or circuit) 116. The circuits 102-116 may represent modules and/or blocks that may be implemented as hardware, software, a combination of hardware and software, or other implementations.

A signal (e.g., X) may be received by the circuit 106. The circuit 106 may generate and transfer a signal (e.g., Y) to the circuit 108. A signal (e.g., Z) may be generated by the circuit 108 and received by the circuit 110. A bitstream signal (e.g., BS) may be generated by the circuit 110 and transferred to the circuit 112. The transfer of the signal BS may involve one or more transmission media and/or one or more storage media. A signal (e.g., Z′) may be generated by the circuit 112 and received by the circuit 114. The circuit 114 may generate a signal (e.g., Y′) received by the circuit 116. A signal (e.g., X′) may be generated and presented by the circuit 116.

The circuit (or apparatus or device or integrated circuit) 102 may implement an encoder circuit. The circuit 102 is generally operational to compress and code information (e.g., video pictures) into the signal BS. In some embodiments, the circuit 102 may implement part to all of a video encoder circuit. The circuit 102 may be compliant with, but is not limited to, the MPEG-2 standard and the H.264 standard.

The circuit (or apparatus or device or integrated circuit) 104 may implement a decoder circuit. The circuit 104 is generally operational to decode and decompress the information carried in the signal BS. In some embodiments, the circuit 104 may implement part to all of a video decoder circuit. The circuit 104 may be compliant with, but is not limited to, the MPEG-2 standard and the H.264 standard.

The circuit 106 may implement a quantization (e.g., Q) circuit. The circuit 106 is generally operational to quantize transform coefficient matrices received in the signal X to generate quantized coefficient matrices. The transform coefficient matrices may be generated by other circuitry in the circuit 102. The quantized coefficient matrices may be presented in the signal Y.

The circuit 108 may implement a run-length coder circuit. The circuit 108 is generally operational to run-length code the quantized coefficient matrices and other symbols generated within the circuit 102. The other symbols may include, but are not limited to, the MBA_INC symbols. The run-length coded symbols may be presented in the signal Z to the circuit 110.

The circuit 110 may implement a variable length code (e.g., VLC) coding circuit. The circuit 110 is generally operational to code the symbols received in the signal Z using variable length codes. The coding may be implemented as, but is not limited to, Huffman coding. In some embodiments, the symbols (e.g., macroblock address increment values) may be coded per Table I. The variable length codes may be presented from the circuit 110 in the signal BS.

The circuit 112 may implement a variable length decode (e.g., VLD) circuit. The circuit 112 is generally operational to decode the VLC codes received in the signal BS to recover the original symbols in the signal Z. The decoding performed by the circuit 112 may be an inverse of the coding performed by the circuit 110. The decoding of a VLC generally includes parsing a fixed number of bits from the signal BS, where the fixed number of bits contain the variable length code. A width value, an offset value and an exact location value may be generated from a width/offset table and a location table based on the bits. The signal Z′ may be generated from an increment value table based on the width value, the offset value and exact location value. The signal Z′ generally conveys the symbol decoded from the variable length code received in the signal BS. The VLC operation (circuit 110) and the VLD operation (circuit 112) may be lossless so that the symbols in the signal Z generally match the symbols in the signal Z′.

The circuit 114 may implement a run-length decoder circuit. The circuit 114 is generally operational to run-length decode the symbols as received in the signal Z′. The decoding performed by the circuit 114 may be an inverse of the coding performed by the circuit 108. The decoded information typically includes the quantized coefficient matrices and the other symbols, including the MBA_INC symbols, generated in the circuit 102. The quantized coefficient matrices may be presented from the circuit 114 to the circuit 116 in the signal Y′. The run-length coding operation (circuit 108) and the run-length decoding operation (circuit 114) may be lossless so that the quantized coefficient matrices in the signal Y generally match the quantized coefficient matrices in the signal Y′.

The circuit 116 may implement an inverse quantization circuit. The circuit 116 is generally operational to inverse quantize the quantized coefficient matrices received in the signal Y′ to generate the transform coefficient matrices in the signal X′. The inverse quantization performed by the circuit 116 may be an inverse of the quantization performed by the circuit 106. The transform coefficient matrices may be presented in the signal X′ to other circuitry in the circuit 104 to complete the decoding. The quantization operation (circuit 106) is generally a lossy transform so the transform coefficients in the signal X′ may be close approximations of the transform coefficients in the signal X.

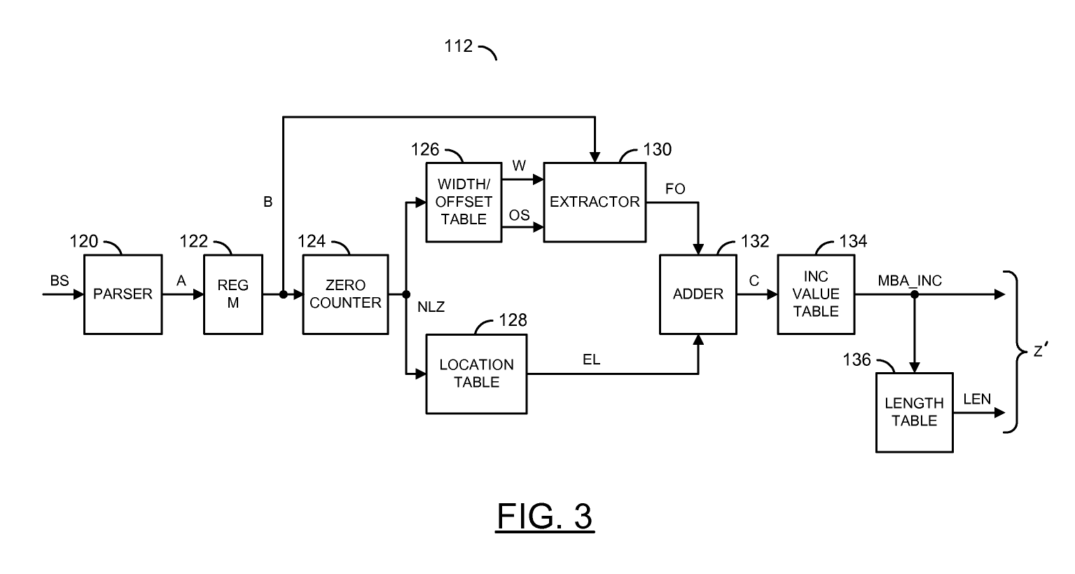

Referring to FIG. 3, a block diagram of an example implementation of the circuit 112 is shown in accordance with a preferred embodiment of the present invention. The circuit (or device or apparatus or integrated circuit) 112 generally comprises a block (or circuit) 120, a block (or circuit) 122, a block (or circuit) 124, a block (or circuit) 126, a block (or circuit) 128, a block (or circuit) 130, a block (or circuit) 132, a block (or circuit) 134 and a block (or circuit) 136. The circuits 120-136 may represent modules and/or blocks that may be implemented as hardware, software, a combination of hardware and software, or other implementations.

The signal BS may be received by the circuit 120. A signal (e.g., A) may be generated by the circuit 120 and presented to the circuit 122. The circuit 122 may generate a signal (e.g., B) transferred to the circuits 124 and 130. A signal (e.g., NLZ) may be generated by the circuit 124 and presented to the circuits 126 and 128. The circuit 128 may generate a signal (e.g., W) transferred to the circuit 130. The circuit 128 may also generate a signal (e.g., OS) transferred to the circuit 130. A signal (e.g., EL) may be generated by the circuit 128 and presented to the circuit 132. A signal (e.g., FO) may be generated by the circuit 130 and received by the circuit 132. The circuit 132 may generate a signal (e.g., C) received by the circuit 134. A signal (e.g., MBA_INC) may be generated by the circuit 134 and received by the circuit 136. The circuit 136 may generate and present a signal (e.g., LEN). A combination of the signal MBA_INC and the signal LEN may form part of the signal Z′.

The circuit 120 may implement a parser circuit. The circuit 120 is generally operational to parse a fixed (or predetermined) number of bits (e.g., 11 bits) from the signal BS. The parsing may be based in part on identification of the start of each VLC code within the signal BS. The parsed bits may be written into the circuit 122 via the signal A.

The circuit 122 may implement a register circuit. The circuit 122 is generally operational to buffer the fixed number of bits received from the circuit 120 in the signal. B. The bits may be read from the circuit 122 in the signal B. In some embodiments, the circuit 122 may be part of the circuit 120.

The circuit 124 may implement a counter circuit. The circuit 124 is generally operational to count a number of leading zeros among the bits buffered in the circuit 122. A number of leading zeros (e.g., NLZ) count value may be presented by the circuit 124 in the signal NLZ. The number of leading zeros count value may be presented to the circuits 126 and 128 as index values.

The circuit 126 may implement a lookup table circuit. The circuit 126 may store a width/offset table. The circuit 126 may be operational to lookup and present a width value in the signal W using the number of leading zeros value in the signal NLZ as an index value. The circuit 126 may also be operational to lookup and present an offset value in the signal OS using the number of leading zeros value in the signal NLZ as an index value. Table II generally shows example values for the width value and the offset value pairs stored in the circuit 126 to decode the MBA_INC_VLC codes as follows:

TABLE II

| Index[i] | {Width, Offset} |
|---|---|
| 0 | {0, 0} |
| 1 | {1, 8} |
| 2 | {1, 7} |
| 3 | {1, 6} |
| 4 | {3, 5} |
| 5 | {5, 4} |
| 6 | {3, 2} |
| 7 | {1, 4} |

The values in Table II may be stored in as few as 2 bytes/pair×8 pairs=16 bytes.

The circuit 128 may implement a lookup table circuit. The circuit 128 may store an exact location table. The circuit 128 may be operational to lookup and present an exact location value in the signal EL using the number of leading zeros value in the signal NLZ as an index value. Table III generally illustrates example values for the exact location values stored in the circuit 128 to decode the MBA_INC_VLC codes as follows:

TABLE III

| Index[i] | Exact Location |
|---|---|
| 0 | 0 |
| 1 | 1 |
| 2 | 3 |
| 3 | 5 |
| 4 | 7 |
| 5 | 15 |
| 6 | 47 |
| 7 | 55 |

The values in Table III may be stored in as few as 1 byte/value×8 values=8 bytes.

The circuit 130 may implement an extractor circuit. The circuit 130 is generally operational to extract a final offset bit-field from the bits stored in the circuit 122. The final offset bit-field generally represents a final offset value in binary form. The final offset value (bit-field) may be presented in the signal FO to the circuit 132.

The circuit 132 may implement an adder circuit. The circuit 132 is generally operational to add the final offset value and the exact location value to create a sum value. The sum value may be presented in the signal. C to the circuit 134.

The circuit 134 may implement a lookup table circuit. The circuit 134 may store an increment value table. The circuit 134 may be operational to lookup and present the decoded symbols (or values) in the signal MBA_INC using the sum value in the signal C as an index value. Table IV may illustrate example values for the symbol values stored in the circuit 134 to decode the MBA_INC_VLC codes as follows:

TABLE IV

| Index[i] | Symbols |
|---|---|
| 0 | 1 |
| 1 | 3 |
| 2 | 2 |
| 3 | 5 |
| 4 | 4 |
| 5 | 7 |
| 6 | 6 |
| 7 | 13 |
| 8 | 12 |
| 9 | 11 |
| 10 | 10 |
| 11 | 9 |
| 12 | 9 |
| 13 | 8 |
| 14 | 8 |
| 15 | 25 |
| 16 | 24 |
| 17 | 23 |
| 18 | 22 |
| 19 | 21 |
| 20 | 21 |
| 21 | 20 |
| 22 | 20 |
| 23 | 19 |
| 24 | 19 |
| 25 | 18 |
| 26 | 18 |
| 27 | 17 |
| 28 | 17 |
| 29 | 16 |
| 30 | 16 |
| 31 | 15 |
| 32 | 15 |
| 33 | 15 |
| 34 | 15 |
| 35 | 15 |
| 36 | 15 |
| 37 | 15 |
| 38 | 15 |
| 39 | 14 |
| 40 | 14 |
| 41 | 14 |
| 42 | 14 |
| 43 | 14 |
| 44 | 14 |
| 45 | 14 |
| 46 | 14 |
| 47 | 33 |
| 48 | 32 |
| 49 | 31 |
| 50 | 30 |
| 51 | 29 |
| 52 | 28 |
| 53 | 27 |
| 54 | 26 |
| 55 | 0 |

The values in Table IV may be stored in as few as 1 byte/value×56 values=56 bytes.

The circuit 136 may implement a lookup table circuit. The circuit 136 may store a length table. The circuit 136 may be operational to lookup and present a length value of the VLC code in the signal LEN using the decoded symbol in the signal MBA_INC as an index value. Table V may illustrate example values for the length values stored in the circuit 136 to decode the MBA_INC_VLC codes as follows:

TABLE V

| Index[i] | Length |
|---|---|
| 0 | 11 |
| 1 | 1 |
| 2 | 3 |
| 3 | 3 |
| 4 | 4 |
| 5 | 4 |
| 6 | 5 |
| 7 | 5 |
| 8 | 7 |
| 9 | 7 |
| 10 | 8 |
| 11 | 8 |
| 12 | 8 |
| 13 | 8 |
| 14 | 8 |
| 15 | 8 |
| 16 | 10 |
| 17 | 10 |
| 18 | 10 |
| 19 | 10 |
| 20 | 10 |
| 21 | 10 |
| 22 | 11 |
| 23 | 11 |
| 24 | 11 |
| 25 | 11 |
| 26 | 11 |
| 27 | 11 |
| 28 | 11 |
| 29 | 11 |
| 30 | 11 |
| 31 | 11 |
| 32 | 11 |
| 33 | 11 |

The values in Table V may be stored in as few as 1 byte/value×34 values=34 bytes.

In some embodiments, one or more of the lookup tables in the circuits 126, 128, 134 and/or 136 may be stored in a ROM memory. Other nonvolatile memory technologies, such as PROM, EPROM, EEPROM, UVPROM and nonvolatile random access memories, may be implemented to meet the criteria of a particular application.

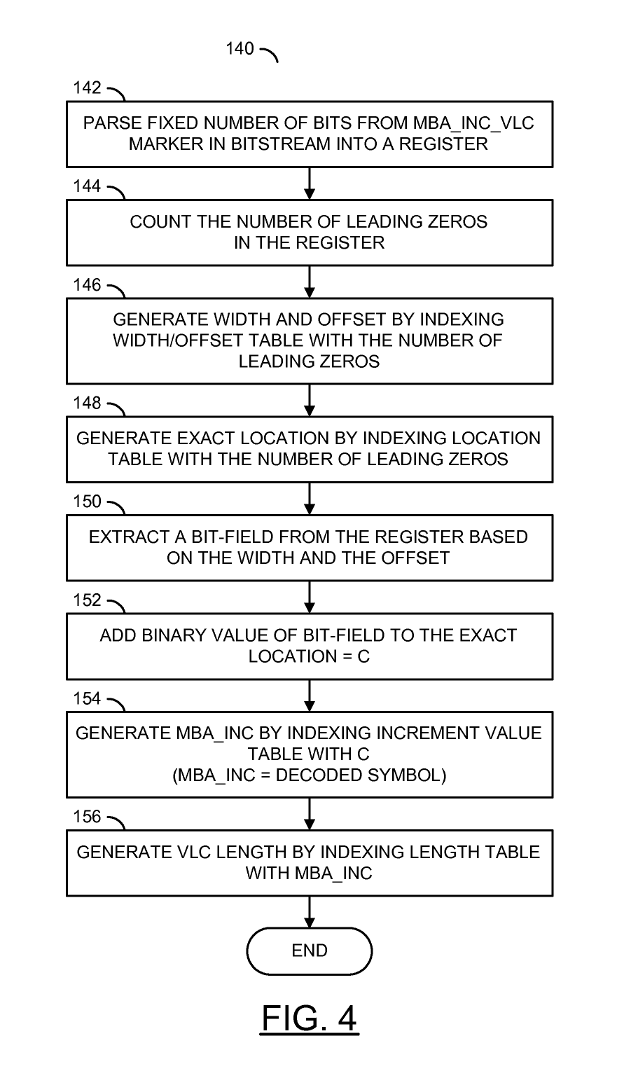

Referring to FIG. 4, a flow diagram of an example method 140 for VLC decoding of a symbol is shown. The method (or process) 140 may be implemented by the circuit 112. The method 140 generally comprises a step (or state) 142, a step (or state) 144, a step (or state) 146, a step (or state) 148, a step (or state) 150, a step (or state) 152, a step (or state) 154 and a step (or state) 156. The steps 142-156 may represent modules and/or blocks that may be implemented as hardware, software, a combination of hardware and software, or other implementations.

In the step 142, the circuit 120 may parse a fixed number of bits (e.g., 11 bits) from the signal BS. The parsed bits may be written into the circuit 122. The circuit 124 may count the number of leading zeros of the bits residing in the circuit 122 during the step 144. A valid range of the number of leading zero values may be 0≦NLZ≦7 in the example because an increment symbol ‘1’ has no leading zeros and the “macroblock_escape” symbol has a maximum number of leading zeros (e.g., 7 leading zeros). The operation of counting the leading zeros from the circuit 122 and placing the count value into another register may be a single-cycle instruction on many advanced digital signal processors currently available to implement the circuit 112. The number of leading zeros may be presented by the circuit 124 in the signal NLZ.

In the step 146, the circuit 126 may use the number of leading zeros value as an index into the width/offset table to look up a corresponding width value and a corresponding offset value. In the step 148, the circuit 128 may use the number of leading zeros value as an index into the exact location table to look up a corresponding exact location value. The circuit 130 may extract a bit-field (e.g., part of the parsed bits buffered in the circuit 122) in the step 150. The extraction may be based on the signal W and the signal OS. A binary value of the bit-field extracted by the circuit 150 may be presented as the final offset value in the signal FO.

In the step 152, the circuit 132 may add the final offset value from the signal FO with the exact location value from the signal EL. The resulting sum value may be presented in the signal C. The circuit 134 may use the sum value as an index to look up a corresponding decoded symbol (e.g., the MBA_INC value) in the step 154. The decoded symbol is generally presented in the signal MBA_INC. In the step 156, the circuit 136 may look up a length value corresponding to the decoded symbol using the decoded symbol as an index. The length value may be presented in the signal LEN.

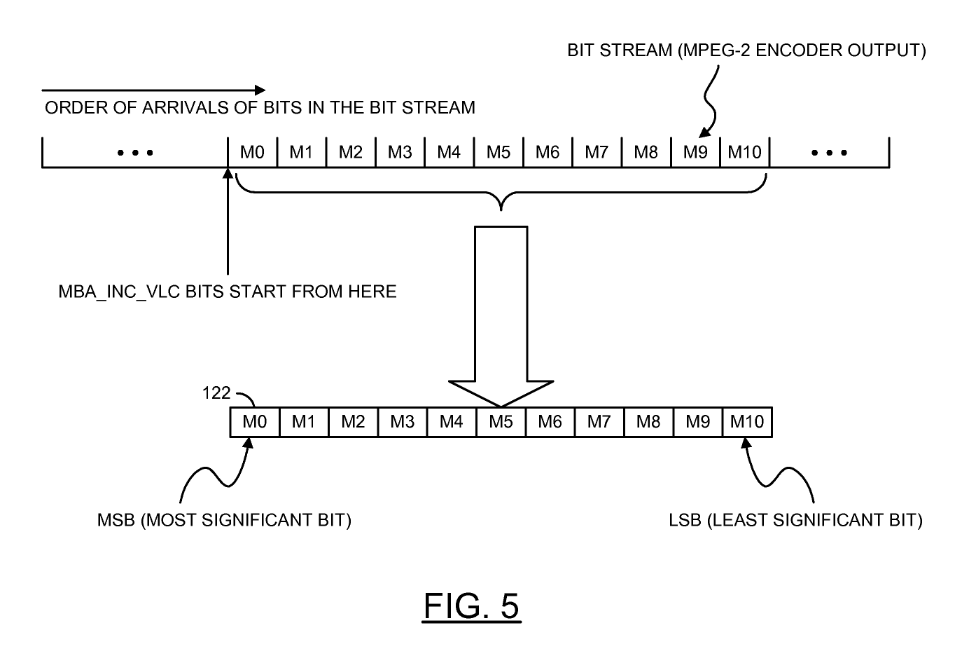

Referring to FIG. 5, a diagram of an example parsing of bits from the signal BS is shown. The signal BS may contain a sequence of bits, shown in order of arrival at the circuit 104 from a most significant bit (e.g., MSB) on the left to a least significant bit (e.g., LSB) on the right. Where a detection of a start of a VLC code is detected (e.g., detection of an MBA_INC_VLC marker in the signal BS), the circuit 120 may copy the next several (e.g., 11) bits from the signal BS into the signal A. An earliest arriving bit among the parsed bits (e.g., bit M0) may be the most significant bit. A latest arriving bit among the parsed bits may be the least significant bit (e.g., bit M10). The bits M0-M10 may be buffered in the circuit 122 for subsequent decoding. The bits M0-M10 may be right-aligned in the circuit 122. Although the example illustrates the circuit 122 as an 11-bit register, other size registers and other numbers of bits may be parsed from the signal BS to meet the criteria of a particular application. For example, the fixed number of bits may be 16 bits or 32 bits.

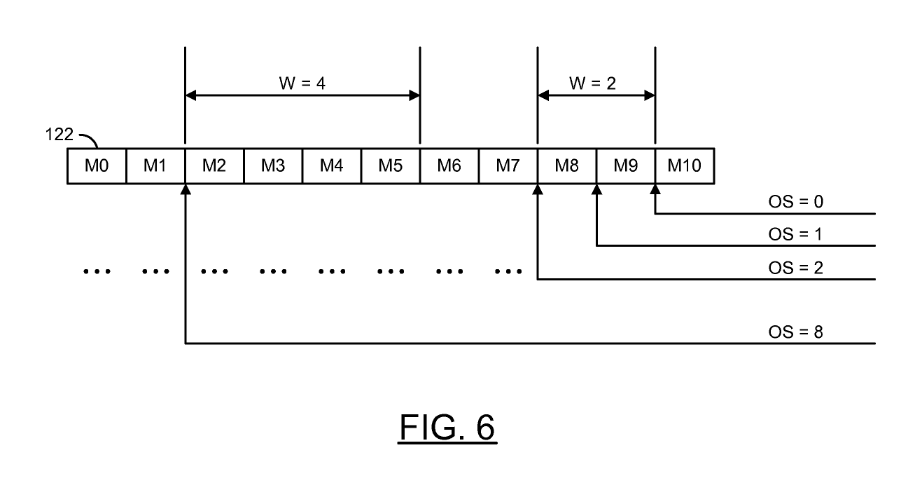

Referring to FIG. 6, a diagram illustrating example bit-field extractions from the circuit 122 based on the width value and the offset value is shown.

By way of example, consider the parsed bits to be 0000 1011 xxx, where each x=0 or 1. Counting the leading number of zeros may result in NLZ=4. In another example, consider the parsed bit to be 1xxx xxxx xxx, where each x=0 or 1. Therefore, the leading number of zeros may be NLZ=0.

The NLZ value may be used as an index (or offset) into the width/offset table of the circuit 126. The circuit 126 may return the width value in the signal W and the offset value in the signal OS. Additionally, use of the NLZ value as an index (or offset) into the exact location table of the circuit 128 generally returns the exact location value in the signal EL. The circuit 126 generally contains ordered pairs of the width values and the offset values. The width values may identify a number of bits to be extracted from the parsed bits. The offset values may identify positions among the parsed bits as measured from a left side of the least significant bit (e.g., M10) from where the bits may be extracted.

In operation, the circuit 130 may extract a bit-field from the parsed bits in the circuit 122 using the width value and the offset value. The width value may have a range of 1≦W≦11. The offset value may have a range of 0≦OS≦10, where W≦OS+1. In a special case, W=0 if OS=0. In the examples illustrated in FIG. 6, the width value of 4 and the offset value of 8 may extract a bit-field of M2|M3|M4⊕M5, where M2=MSB and M5=LSB. The width value of 2 and the offset value of 2 may extract a bit-field of M8|M9, where M8=MSB and M9=LSB. For the special case of W=OS=0, the extracted bit-field may be 0|0, where MSB=0 and LSB=0. A binary value represented by the extracted bit-field may be presented in the signal FO. The extraction operation is typically a single-cycle instruction on many advanced digital signal processors currently available.

A sum value is generally calculated by adding the exact location value and the final offset value. The final offset value may be used to look up the decoded symbol values (e.g., symbol 1 to symbol macroblock_escape) from the increment value table of the circuit 134. The symbol values may be used to look up the VLC code lengths (e.g., 1 bit to 11 bits) from the length table of the circuit 136. The decoded symbol and the length value may be used for further processing of the MPEG-2 video bit stream in the MPEG-2 video decoder.

The following examples generally exemplify the VLC code decoding procedure.

### Example 1

Step 142 may parse a set of bits 0000 0101 011 from the signal BS. The parsed bits generally contain the VLC code 0000 0101 01 (symbol 18 in Table I) with an extra least significant bit of 1. The number of leading zeros may be 5 per the count of step 144. Indexing the circuit 126 with the value of 5 in the step 146 generally returns the width value of 5 and the offset value of 4 (e.g., Table II[5]={5,4}). Indexing the circuit 128 with the value of 5 in the step 148 may return the fifth exact location value of 15 (e.g., Table III[5]=15). In the step 150, the circuit 130 may extract the bit-field 01011 from the circuit 122 based on the width value 5 and the offset value 4. The binary value of the bit-field 01011 may be 11 decimal. Adding the value 11 to the value 15 in the step 152 may result in a sum value of 11+15=26. Indexing the circuit 134 with the value of 26 in the step 154 generally provides a value of 18 (e.g., Table IV[26]=18). The value of 18 may be the decoded symbol. Indexing the circuit 136 with the value of 18 in the step 156 may produce a length of 10 (e.g., Table V[18]=10). The 10 most significant bits of the parsed bits may be 0000 0101 01, which corresponds to the symbol 18 in Table I.

### Example 2

The parsed bits may be 0100 0101 011, which represent the VLC code 010 with 8 extra least significant bits. The number of leading zeros may be 1. The width value/offset value from Table II[1]={1,8}. The exact location value from Table III[1]=1. The extracted bit-field may be 0. The binary value of the bit-field 0 may be zero. The sum of 0+1=1. The symbol value from Table IV[1]=3. The length value from Table V[3]=3. Therefore, the 3 most significant parsed bits among 0100 0101 011 may be (the VLC code) 010, which corresponds to the symbol 3 per Table I.

### Example 3

The parsed bits may be 1000 0000 011, which represent the VLC code 1 with 10 (ten) extra least significant bits. The number of leading zeros may be 0. The width value/offset value from Table II[0]={0,0}. The exact location value from Table III[0]=0. The extracted bit-field may be 0. The binary value of the bit-field 0 may be zero. The sum of 0+0=0 (see FIG. 6 where OS=0 with W=0). The symbol value from Table IV[0]=1. The length value from Table V[1]=1. Therefore, the most significant parsed bit among 1000 0000 011 may be (the VLC code) 1, which corresponds to the symbol 1 per Table I.

A sum of the table sizes for the Table II to Table V is 16+8+56+34=114 bytes. A ROM that stores only 114 bytes may be smaller than a typical VLC decoding ROM that stores 240 bytes (e.g., a savings of greater than 50% in the ROM size). A person of ordinary skill in the art may adapt the methodology and tables presented herein for VLC decoding in other digital signal processing applications and/or other mappings between the symbols and the variable length codes.

The tables used for the VLC decoding of the macroblock address increment variable length codes may use a low memory among comparable implementations of the existing MPEG-2 video decoders. In addition to low memory usage, a performance of the VLC decoding is generally not compromised in terms of clock cycles. Reduction in the ROM size to store the decoding tables generally helps system designers in terms of cost, silicon area and simplicity of design. The VLC decoding may be adapted to decoding other variable length codes in other signal processing applications (e.g., video and audio).

The functions performed by the diagrams of FIGS. 2-6 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

As would be apparent to those skilled in the relevant art(s), the signals illustrated in FIGS. 2 and 3 represent logical data flows. The logical data flows are generally representative of physical data transferred between the respective blocks by, for example, address, data, and control signals and/or busses. The system represented by the circuit 112 may be implemented in hardware, software or a combination of hardware and software according to the teachings of the present disclosure, as would be apparent to those skilled in the relevant art(s).

While the invention has been particularly shown and described with reference to the preferred embodiments thereof, it will be understood by those skilled in the art that various changes in form and details may be made without departing from the scope of the invention.

1. An apparatus comprising:
a first circuit configured to parse a fixed number of bits from a first signal, wherein said bits contain a variable length code; and
a plurality of lookup tables configured to (i) generate a first value, a second value and a third value from a first and a second of said tables based on said bits and (ii) generate a second signal from a third of said tables based on said first value, said second value and said third value, wherein said second signal conveys a symbol decoded from said variable length code.

2. The apparatus according to claim 1, wherein said apparatus forms part of an MPEG-2 decoder.

3. The apparatus according to claim 1, further comprising a second circuit configured to count a leading number of zeros in said bits.

4. The apparatus according to claim 3, wherein said first table is indexed with said leading number of zeros to generate said first value and said second value.

5. The apparatus according to claim 3, wherein said second table is indexed with said leading number of zeros to generate said third value.

6. The apparatus according to claim 1, further comprising a fourth of said tables indexed by said symbol to generate a length of said variable length code.

7. The apparatus according to claim 1, further comprising a second circuit configured to generate a fourth value by extracting a subset of said bits based on said first value and said second value.

8. The apparatus according to claim 7, further comprising a third circuit configured to generate a fifth value by adding said third value to said fourth value.

9. The apparatus according to claim 8, wherein said third table is indexed with said fifth value to generate said symbol.

10. The apparatus according to claim 1, wherein said apparatus is implemented as one or more integrated circuits.

11. A method for decoding a variable length code, comprising the steps of:
(A) parsing a fixed number of bits from a first signal, wherein said bits contain said variable length code;
(B) generating a first value, a second value and a third value from a first and a second of a plurality of tables based on said bits; and
(C) generating a second signal from a third of said tables based on said first value, said second value and said third value, wherein said second signal conveys a symbol decoded from said variable length code.

12. The method according to claim 11, wherein said decoding forms part of an MPEG-2 decoding.

13. The method according to claim 11, further comprising the step of:
counting a leading number of zeros in said bits.

14. The method according to claim 13, wherein said generation of said first value and said second value comprises indexing said first table with said leading number of zeros.

15. The method according to claim 13, wherein said generation of said third value comprises indexing said second table with said leading number of zeros.

16. The method according to claim 11, further comprising the step of:
generating a length of said variable length code by indexing a fourth of said tables with said symbol.

17. The method according to claim 11, further comprising the step of:
generating a fourth value by extracting a subset of said bits based on said first value and said second value.

18. The method according to claim 17, further comprising the step of:
generating a fifth value by adding said third value to said fourth value.

19. The method according to claim 18, wherein said generation of said symbol comprises indexing said third table with said fifth value.

20. An apparatus comprising:
means for parsing a fixed number of bits from a first signal, wherein said bits contain a variable length code;
means for generating a first value, a second value and a third value from a first and a second of a plurality of tables based on said bits; and
means for generating a second signal from a third of said tables based on said first value, said second value and said third value, wherein said second signal conveys a symbol decoded from said variable length code.
